(19) United States
(12) Patent Application Publication
(10) Pub. No.: US 2004/0086118 A1
(43) Pub. Date: May 6, 2004

(54) Encrypting and decrypting optical communications with matched encoders and decoders

(76) Inventors: John N. Sweetser, San Jose, CA (US); Alan E. Johnson, San Jose, CA (US); Anders Grunnet-Jepsen, San Jose, CA (US); Aaron R. Rickerson, Suffolk, VA (US)

Correspondence Address: TROP PRUNER & HU, PC, 8554 KATY FREEWAY, SUITE 100, HOUSTON, TX, 77024, US

(21) Appl. No.: 10/284,638

(22) Filed: Oct. 31, 2002

(51) Int. Cl. G09C 5/00

(52) U.S. Cl. 380/54

(57) ABSTRACT

An optical signal may be encrypted and decrypted using an encoder and a matched decoder. In this way, an encoded signal may be retrieved using a decoder that matches the encoder. The encoder may alter the phase or amplitude of the signal.

### BACKGROUND

This invention relates generally to transmitting optical signals and, particularly, to techniques for encrypting and decrypting optical signals in optical signal transmission systems.

It is well known to encrypt an electrical signal prior to its electrical transmission. On the receiving end, the electrical signals may be decrypted. As a result, the ease with which an unauthorized person may intercept a communication may be sufficiently decreased to reduce the likelihood of interception.

In optical systems, it has generally been considered unnecessary to encrypt or decrypt signals. Commonly, optical signals are derived from electrical signals which may already be encrypted.

Particularly where optical signals are transmitted over long distances, it may be desirable to encrypt, and subsequently decrypt, these signals to improve security.

Thus, there is a need for better ways to encrypt and decrypt optical signals.

### BRIEF DESCRIPTION OF THE DRAWINGS

FIG. 1A is a schematic depiction of original data in accordance with one embodiment of the present invention;

FIG. 1B is a schematic depiction of encoded data in accordance with one embodiment of the present invention;

FIG. 1C is a schematic depiction of complementary encoded data in accordance with one embodiment of the present invention;

FIG. 1D is a schematic depiction of transmitted encoded data in accordance with one embodiment of the present invention;

FIG. 2 is a schematic depiction of an encoder in accordance with one embodiment of the present invention;

FIG. 3 is a schematic depiction of a decoder in accordance with one embodiment of the present invention;

FIG. 4 is a schematic depiction of an intervener indicated at A that attempts to tap into a communication link between a secure transmitter and a secure receiver in accordance with one embodiment of the present invention;

FIG. 5 is a schematic depiction of an encoder in accordance with another embodiment of the present invention;

FIG. 6A is a depiction of an example of input data in accordance with one embodiment of the present invention;

FIG. 6B is a depiction of an example of decoded data in accordance with one embodiment of the present invention;

FIG. 6C is an example of decoded complementary data in accordance with one embodiment of the present invention;

FIG. 6D is a schematic depiction of the type of information that might be obtained at A in FIG. 4 in an embodiment illustrated in FIGS. 6A through 6C;

FIG. 7 is a schematic depiction of a modified encoder in accordance with one embodiment of the present invention; and

FIG. 8 is a schematic depiction of a modified decoder in accordance with one embodiment of the present invention.

### DETAILED DESCRIPTION

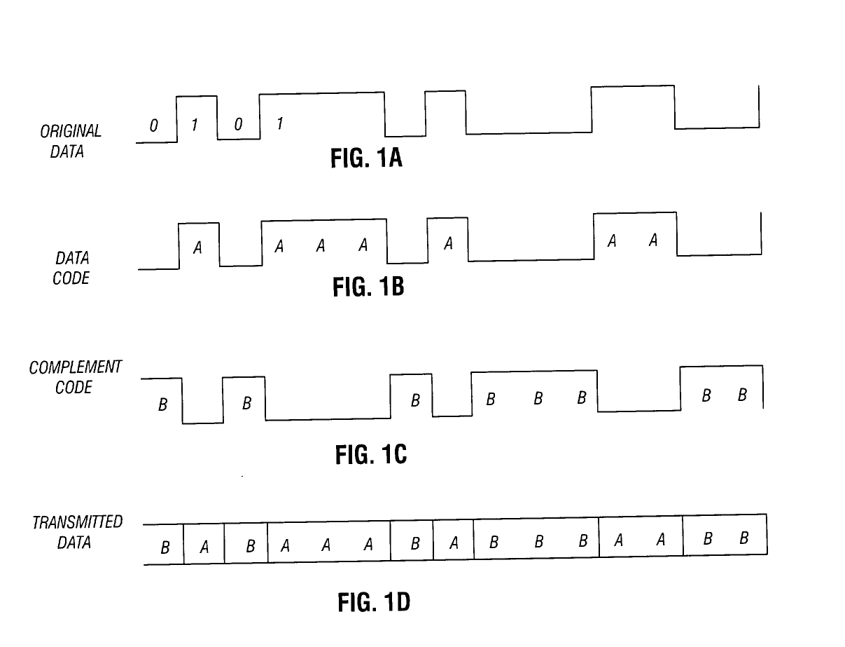

In a system for secure optical communications, a data stream, shown in FIG. 1A, is transmitted along a medium at the same time as its complementary data stream shown in FIG. 1C. The data stream is identified with a given optical code (“A”), as shown in FIG. 1B, and the complementary data stream is identified with a different optical code (“B”) such that every “1” in the data stream is indicated by the presence of a first code and every “0” in the data stream is indicated by the presence of a second code. When the data sequence and the complementary data sequence are sent at the same time, the average energy may be substantially constant in some embodiments. The cotemporal data and complementary data sequences are shown in FIG. 1D in accordance with one embodiment of the present invention.

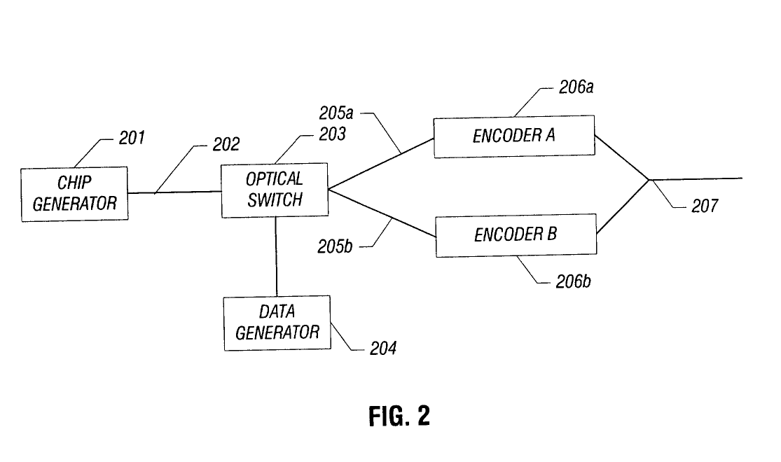

A transmitter capable of generating a secure data sequence according to one embodiment of the present invention is shown in FIG. 2. The optical chip generator 201 generates a series of short pulses, or optical chips, at the clock rate. These optical chips are provided to the optical transport 202. The optical chips are then received by an optical switch 203, whose state is determined by the input electrical data sequence from a data generator 204.

The length of the optical transport 202 may be such that a chip enters the optical switch 203 when the optical switch 203 is in one of its two states and not during a switching transition in one embodiment. For a data value of “1,” the optical switch 203 directs the optical chip to the optical transport 205a and for a data value of “0” the optical switch 203 directs the optical chip to the optical transport 205b.

An optical chip traveling along the optical transport 205a is optically encoded by an encoder 206a. An optical chip traveling along the optical transport 205b is optically encoded by encoder 206b. The optical encoders 206a and 206b may be Bragg gratings (fiber or planar waveguides) or any other optical encoding device such as a surface grating, a thin film filter, an integrated interference device (arrayed waveguide grating), etc. In general, any device that alters the phase and/or the amplitude of the optical chip in a controlled and reproducible fashion may be considered an optical encoder according to embodiments of the present invention. Such an encoder may be static or programmable. In the case that the optical encoders 206a and 206b are Bragg gratings, optical circulators may be inserted to extract the back-reflected encoded light. Alternatively, the encoded light may be extracted using interferometric devices, such as Mach-Zehnder interferometers. The optical streams are recombined with a passive splitter 207 yielding the cotemporal, encoded data and encoded complementary data streams.

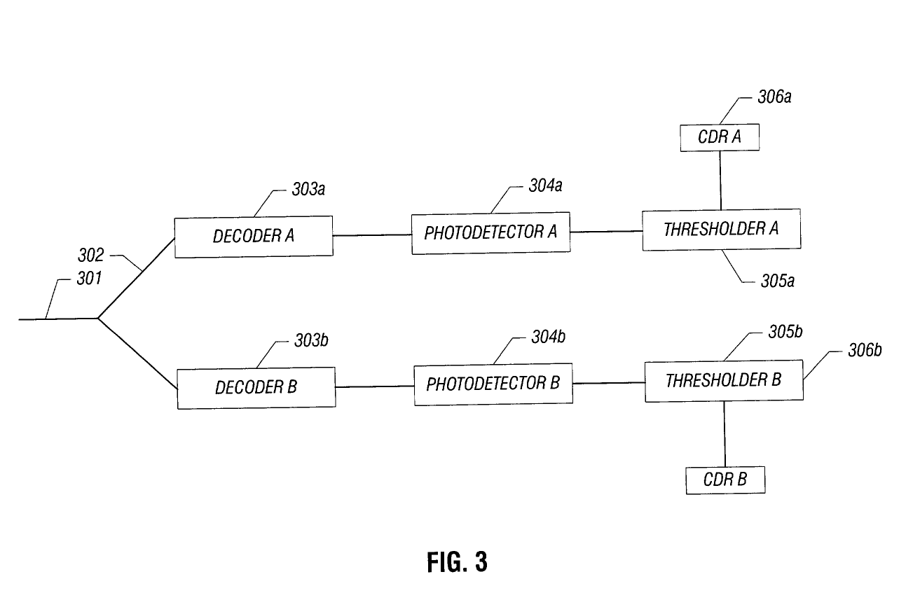

A receiver to detect a secure data sequence according to one embodiment of the present invention is shown in FIG. 3. Cotemporal encoded data and complementary data streams enter the receiver along the optical transport 301. The data streams, split into two portions (which may be equal portions in one embodiment) using a passive splitter 302, may be directed to decoders 303a and 303b. The decoded outputs are directed to photodetectors 304a and 304b and electronically processed with thresholders 305a and 305b and clock and data recovery (CDR) 306a and 306b yielding the output electrical data sequence and its complement. These matched encoders and decoders are used to encrypt and decrypt the optical signal. In a separate embodiment, only the actual data sequence is recovered and the complementary data sequence is not recovered.

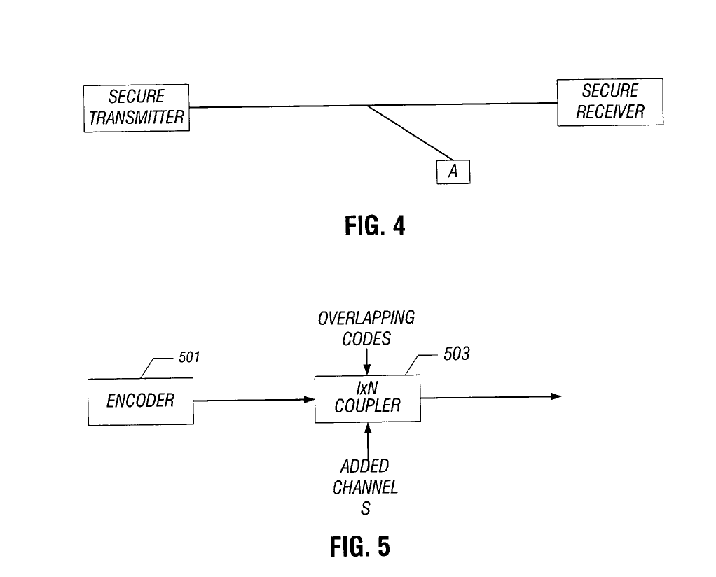

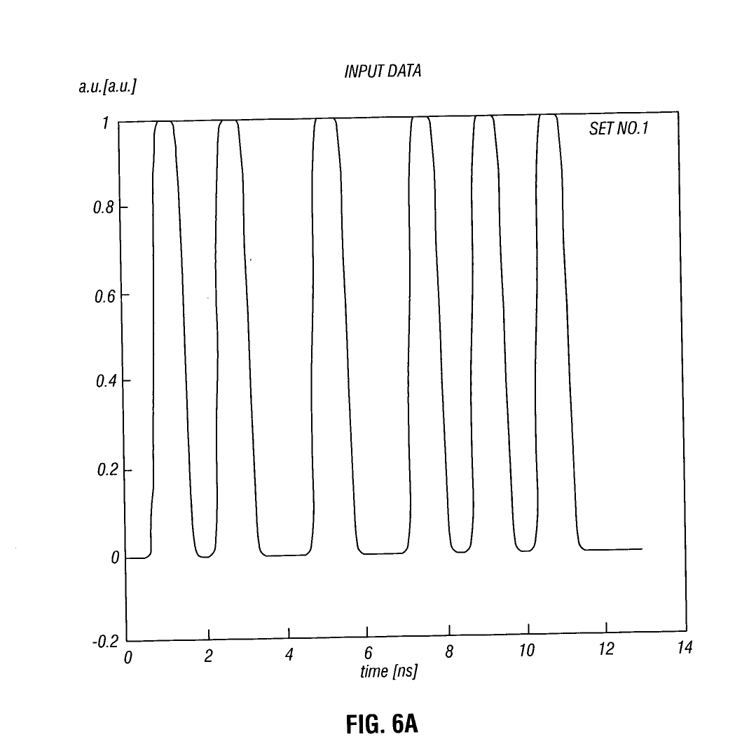

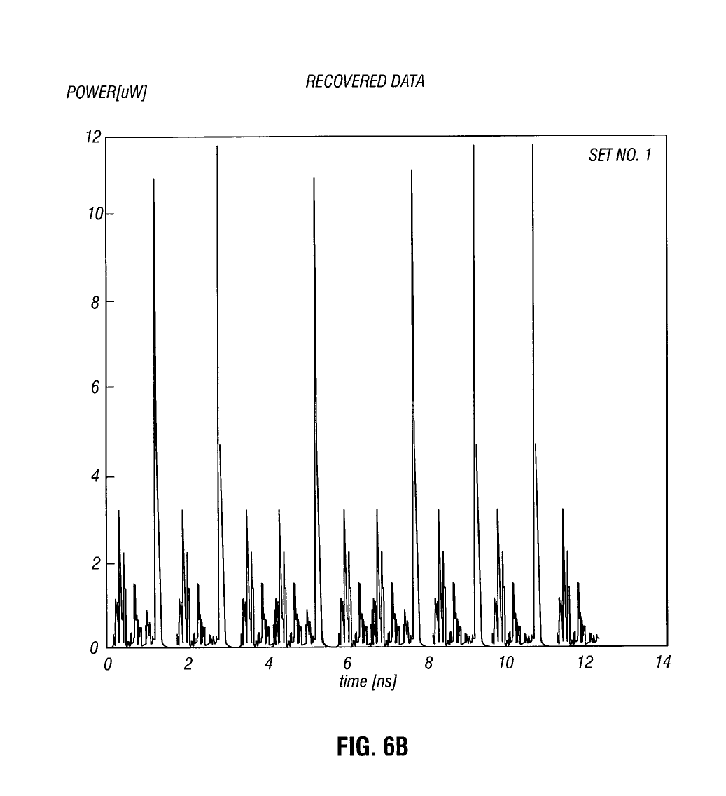

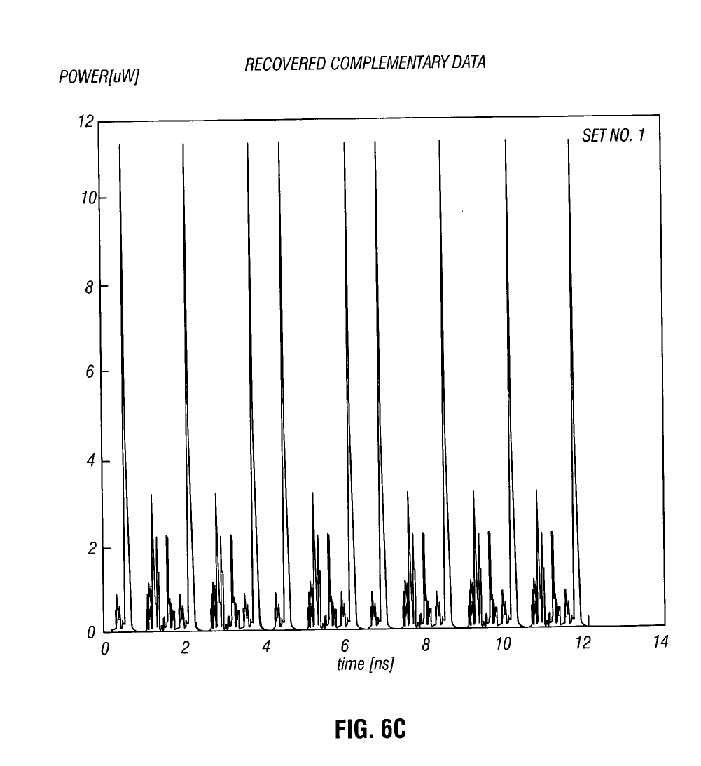

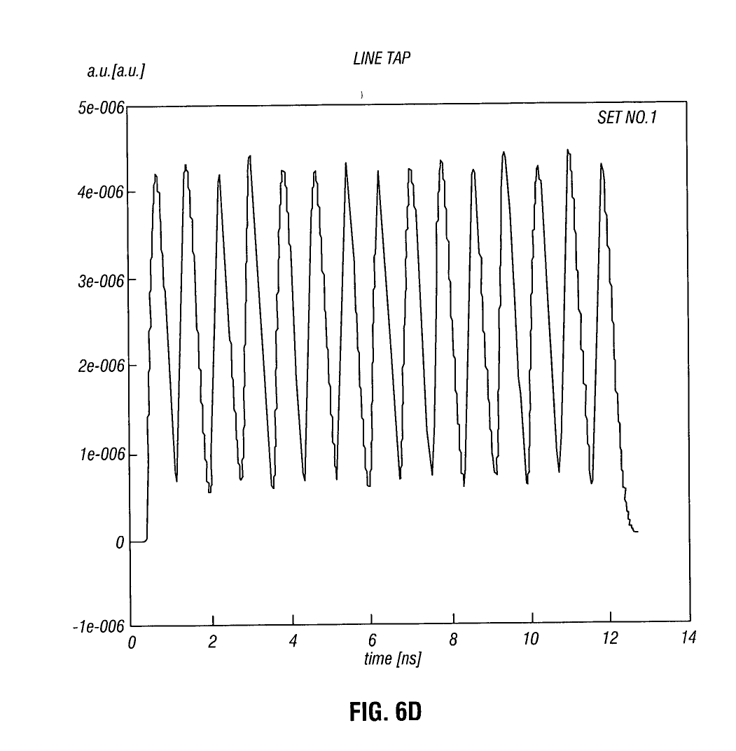

A secure transmission system is shown in FIG. 4. For the data sequence shown in FIG. 6a and a chosen set of codes, the decoded data and complementary signals shown in FIGS. 6b and 6c are recovered. Simple thresholding electronics allows one to easily discriminate between ones and zeros in one embodiment.

Alternatively, the thresholding to increase the contrast between the received “1's” and “0's” may be achieved using non-linear optical detection methods. Such methods use an optical material that responds non-linearly to the input signal, which has the effect of enhancing the contrast between low intensity and high intensity optical pulses. Using non-linear optical detection, the ratio between the received data from the matched codes and the background signal from the mismatched codes in FIGS. 6a and 6b may be significantly increased. In the case of non-linear optical thresholding, the thresholding function may occur before the photodetectors (304a and 304b in FIG. 3). The main advantage of non-linear optical thresholding is speed. Non-linear optical processes are much faster than electronic ones so the detection electronic speed requirements are relaxed. The disadvantage is that non-linear optical processes are generally inefficient so that more optical power is required for detection than would be using direct electronic detection and thresholding.

A person tapping the line at point A, in FIG. 4, using a photoreceiver with a bandwidth comparable to the data rate only observes the “clock” as seen in FIG. 6d. While there are some fluctuations that are correlated with the data, the magnitude of those fluctuations is typically comparable to or smaller than the noise level which renders the bits practically indistinguishable.

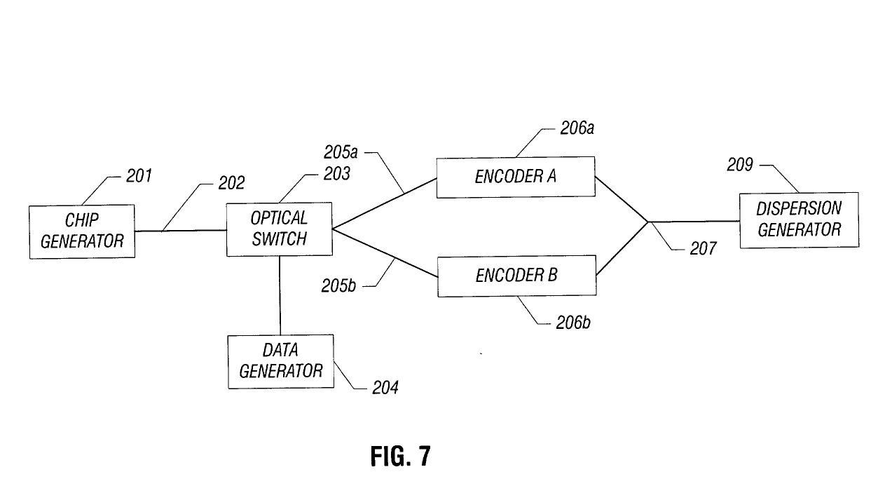

In a further embodiment of the present invention, shown in FIG. 7, optical dispersion is used to improve the security. Dispersion provides a controlled and reproducible frequency dependent phase shift that may be used alone as a coding technique according to one embodiment of the present invention. In some embodiments, however, the same dispersion is applied to both the data channel and the complementary data channel. Prior to transmission, the secure transmission signal is passed through a dispersion generator 209 of known character to further scramble the signal. The character of this generator 209 may be considered a variable that may be changed from installation to installation to enhance security.

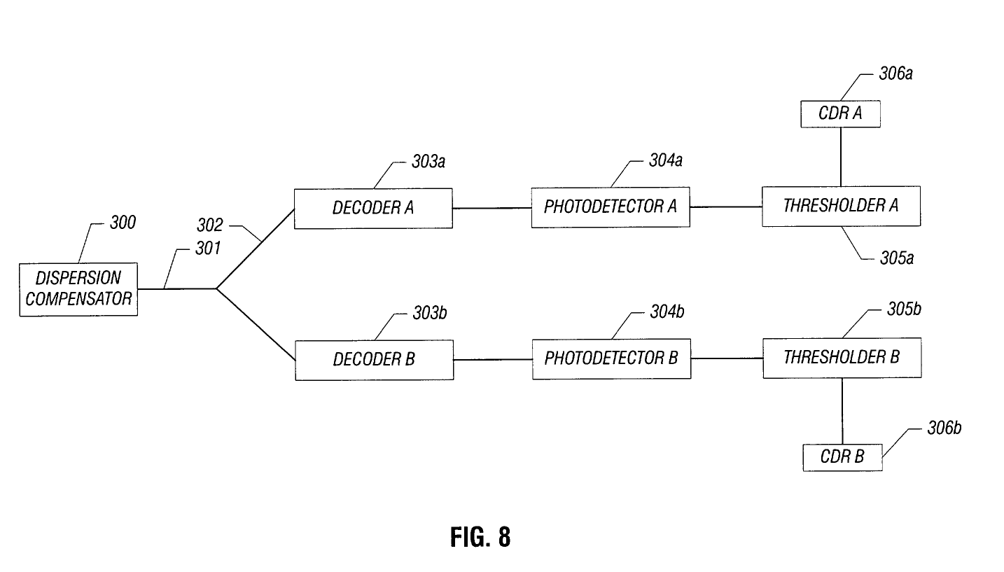

At the receiver, shown in FIG. 8, a dispersion compensator 300 is employed to reverse the dispersion caused by the dispersion generator in the transmitter. Utilization of dispersion causes intersymbol interference and coherent beating between subsequent bits during transmission and further enhances security. In a further embodiment the dispersion compensator 300 at the receiver may compensate for the dispersion caused the dispersion compensator 209 in the transmitter and the dispersion of the transmission medium.

In some embodiments different optical codes identify the data stream and the complementary data stream. The codes for the data stream and the complementary stream may be practically indistinguishable without the correct decoder. Optical data codes are distinguishable by their temporal and/or spectral structure. The two limiting cases are (1) codes which are temporally distinguishable and spectrally indistinguishable and (2) codes which are temporally indistinguishable and spectrally distinguishable. Codes which are spectrally indistinguishable are an important class because a person tapping the line may not use a narrowband spectral filter to successfully discriminate between codes (i.e., “1” and “0” bits). Furthermore, the bandwidth of the code can be made very high relative to the signal processing electronics required to discriminate between the codes in the time domain.

The larger the encoding bandwidth, the more difficult the data discrimination can be made. As a simple example of (1), data and complementary data codes that are the time-reverse of each other are spectrally identical, yet temporally distinct (assuming they are not perfectly symmetric in time). If the temporal structure of the encoded signals were fast enough as to be unresolvable using direct photodetection, then the tapped data stream would be very difficult to decrypt. In general, however, optimum code sets may have some degree of distinguish-ability in both time and frequency domains.

One aspect of this embodiment is that the two encoded data streams do not overlap in time. The codes are designed such that the encrypted signal looks substantially uniform in time, i.e., there is very little difference between the “1” and “0” bits. In some embodiments the codes may be changed at periodic or random intervals.

In a second embodiment, shown in FIG. 5, only the data bits are encoded and transmitted. In this case, there is a clear distinction between “1” and “0” bits, so one or more additional codes, which do overlap with the data bits, are sent in order to achieve secure transmission. The data is encoded at 501 and overlapping codes are added to the signal, for example, using a 1xN coupler 503. The added codes may contain any bit pattern (e.g., random or all “1”s) such that there is substantial overlap with the encoded data bits.

One advantage of this approach is that, since the codes overlap in time and spectrum, there is significant optical interference in the transmitted signal resulting in a dynamic noise-like quality in the encrypted signal. Because the signal randomly evolves in time, it is potentially more difficult to decipher than the first embodiment. This embodiment is conceptually similar to synchronous optical code division multiplexing (CDM) and, thus, the appropriate code sets are similar or identical to those used for synchronous CDM.

Another advantage of this embodiment is the possibility of using the added channels to send additional information over the link, e.g., information about the channel or other data channels (i.e., CDM). By adding more encryption channels to the encoded data channel, a higher level of security is achieved. However, more codes used for encryption requires more bandwidth. Also, because of the overlapping codes, the number of usable codes is smaller than in the previous embodiment. At the receiver, a decoder matched to the data code is used in conjunction with processing electronics to recover the transmitted data.

A third embodiment involves the use of a single encoder/decoder for data encryption. This embodiment relies on the temporal stretching of individual bits and the interference between sequential bits (inter-symbol interference) to achieve security. If bits are stretched by longer than a bit period, then consecutive “1”s will interfere with each other and become difficult to distinguish. Larger stretching results in more interference and more secure transmission.

The encoding can be achieved using devices similar to those used in the prior embodiments. The exception is that the encoders may be longer than the bit period in order to ensure significant overlap of bits. However, too much overlap may lead to significant spectral distortion of the data leaving it unrecoverable.

As in the prior embodiments, a matched coder and decoder properly decipher the data. Conventional optical dispersion (e.g., from fiber or Bragg grating device) is a simple example of this type of encryption. More complex phase and amplitude codes that are optimized for encryption of this type may be preferable. Finally, this embodiment may be used alone or in conjunction with the prior embodiments to enhance security.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
encrypting an optical signal using an encoder; and
optically decrypting the signal using a decoder matched to said encoder.

2. The method of claim 1 including providing a data code and its complementary data code for said signal.

3. The method of claim 1 including causing temporal overlap between the signal containing information to be transmitted and another signal.

4. The method of claim 3 including using codes designed for optical code division multiplexing.

5. The method of claim 1 including causing successive bits of said signal to overlap in time.

6. The method of claim 1 including encrypting a code and a complement code.

7. The method of claim 1 including encrypting a code and a complement code and decrypting only a code.

8. The method of claim 1 including causing the average energy of the encrypted signal to be substantially constant in time.

9. The method of claim 1 including using Bragg gratings to encrypt or decrypt said signal.

10. The method of claim 1 wherein decrypting the signal includes using a threshold detecting device to decode said signal.

11. The method of claim 1 including compensating for dispersion.

12. The method of claim 1 including encoding the signal by altering its temporal or spectral amplitude.

13. The method of claim 1 including encoding the signal by altering its temporal or spectral phase.

14. An optical transmission system comprising:
an optical link;
an optical transmitter coupled to said link to encrypt an optical signal using an encoder; and
an optical receiver coupled to said link to decrypt a received signal using a decoder matched to said encoder.

15. The system of claim 14 wherein said encoder provides a complementary code and a data code.

16. The system of claim 14 wherein said encoder causes temporal overlap between the optical signal and another signal.

17. The system of claim 16 wherein said encoder uses code division multiplexing.

18. The system of claim 14 wherein said encoder causes successive bits to overlap in time.

19. The system of claim 14 wherein said encoder includes a code and a code complement.

20. The system of claim 19 wherein said decoder decrypts only a code or a code complement.

21. The system of claim 14 wherein said encoder includes a Bragg grating.

22. The system of claim 14 wherein said decoder includes a threshold detecting device.

23. The system of claim 14 wherein said receiver includes a device to compensate for dispersion.

24. The system of claim 14 wherein said encoder alters the temporal or spectral amplitude of an optical signal.

25. The system of claim 14 wherein said encoder alters the temporal or spectral phase of an optical signal.

26. An optical encryption device comprising:
a chip generator;
an optical switch coupled to said chip generator; and
a pair of encoders, one of said encoders encoding a first code on a data signal from said optical switch and the second of said encoders encoding a signal that is the complement of said data signal.

27. The device of claim 26 wherein each of said encoders applies a different code to the data and its complement.

28. The device of claim 26 including dispersion compensation or dispersion generation.

29. The device of claim 26 wherein the average energy of said encoded signals is substantially constant in time.

30. The device of claim 26 wherein said encoder includes a component that alters the amplitude or phase of an optical bit.

31. The device of claim 30 wherein said component is a Bragg grating.

32. The device of claim 30 wherein said component is an arrayed waveguide grating.

33. The device of claim 30 wherein said component is a thin film filter.
